(19) United States
(12) Patent Application Publication
(10) Pub. No.: US 2016/0292653 A1
(43) Pub. Date: Oct. 6, 2016

(54) SYSTEM AND METHOD FOR MANAGING COLLECTION OF WASTE RESOURCES

(71) Applicant: Ron Gonen, New York, NY (US)

(72) Inventor: Ron Gonen, New York, NY (US)

(21) Appl. No.: 15/060,717

(22) Filed: Mar. 4, 2016

Related U.S. Application Data
(60) Provisional application No. 62/141,691, filed on Apr. 1, 2015.

(51) Int. Cl. G06Q 10/00; G06Q 10/10

(52) U.S. Cl. CPC G06Q 10/30; G06Q 10/1097

(57) ABSTRACT

System and method to manage collection of waste resources. The system may include a non-transitory computer readable medium to store instructions that, when executed by a processor, perform operations to collect waste resources from a plurality of customers. Embodiments plan the collection and processing of waste resources, and allocate rewards to customers based on their respective recycled waste resources. The system may also include a resource management system, a server, and a communication interface to a communication network in order to communicate with customers. Embodiments also may include a database to store the customers' information along with the rewards allocated to customers.

### CROSS-REFERENCE TO RELATED APPLICATIONS

This application claims the benefit of U.S. Provisional Patent Application Ser. No. 62/141,691 filed on Apr. 1, 2015, the entire content of which is hereby incorporated by reference in its entirety.

### BACKGROUND

1. Field

Embodiments of the present invention generally relate to a system and method to manage waste resources. In particular, embodiments relate to a system and method to manage the collection of waste resources and provide incentives to a user for participating.

2. Description of Related Art

It is estimated that the average U.S. household throws out 300 pounds of used clothing, shoes, and sheets every year. This waste stream results in about 80 million tons of such used articles sent annually to landfills. It is also estimated that an additional 2 million tons of electronic waste is generated annually in the U.S. Consumers (through either municipal collection cost or the cost of private haulers) pay at least $400 million annually to dispose of such used articles. Furthermore, usage of landfill capacity for such items in some locations may be discouraged, either by policy or by law. Therefore, ways of reducing cost and the waste stream are attractive.

The recycling industry has become more active in recent years. Increasing amounts of waste resources are being recycled in order to reduce disposal costs and reduce demand for natural resources. Therefore, companies and industries conduct various recycling processes and encourage consumers to recycle more and more waste resources. Conventionally, collected waste resources are disposed in landfills. However, the cost of waste resource disposal in various cities has increased as landfill capacity for disposing the waste resources has decreased. Further, collection and disposal of electronic waste or textile waste from household is not an easy job.

For example, scrap cars, appliances, electronic waste (e.g., televisions, computers), and the like, are difficult to collect and then dispose because the waste may include metals that can give rise to environment pollution, may contain toxic, dangerous or harmful products (e.g., chemicals, compressed gas cylinders), or may require governmental permits for lawful disposal or recycling (e.g., asbestos products). Also, textile waste such as apparel, footwear, bedding, and the like, typically is not disposed in landfills as they can have an adverse effect on the environment if ground water causes clothes to decompose in a way that can spread biological hazards. Therefore, conventional systems refrain from collecting electronic or textile waste from households or industries.

Thus, there is a need for an improved technique to manage the collection of waste resources and encourage customers to take part in waste management processes.

### SUMMARY

Embodiments provide a system and method to manage the collection of waste resources. In one embodiment, a system comprises a non-transitory computer readable medium to store instructions that, when executed by a processor, perform operations to support collection of waste resources from a plurality of customers. Further, the waste resources are processed and rewards may be allocated to the plurality of customers based on the recycled waste resources. The system also includes, but is not limited to, a resource management system, a server, and an interface to a communication network to communicate between the resource management system and the plurality of customers. There is also provided a database to store the customers' information along with the rewards allocated to the customers.

### BRIEF DESCRIPTION OF DRAWINGS

So that the manner in which the above recited features of the present embodiments may be understood in detail, a more particular description of embodiments of the present invention, briefly summarized above, may be had by reference to embodiments, several of which are illustrated in the appended drawings.

The above and still further features and advantages of the present disclosure will become apparent upon consideration of the following detailed description of embodiments thereof, especially when taken in conjunction with the accompanying drawings wherein like reference numerals in the various figures are utilized to designate like components, and wherein:

FIG. 1 is a system to manage the collection of waste resources, according to an embodiment of the present invention;

FIG. 2 illustrates a high level hardware abstraction of a block diagram of a server, according to an embodiment of the present invention;

FIG. 3 illustrates a method to submit a request to collect waste resources, according to an embodiment of the present invention;

FIG. 4 illustrates a method to manage the collection of waste resources, according to an embodiment of the present invention;

FIG. 5A illustrates a user interface of a user equipment to submit a request to collect waste resources, according to an embodiment of the present invention;

FIG. 5B illustrates a user interface to confirm a request to collect waste resources, according to an embodiment of the present invention;

FIG. 6 illustrates a route report in accordance with an embodiment of the present disclosure; and

FIG. 7 illustrates computing hardware that can be used to implement various exemplary embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description.

Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

The value of electronic waste can very significantly. Valuable items may lead to a profit if the valuable items are identified, refurbished, and resold (e.g., smart phones, tablet PCs, video game consoles, etc.). Conversely, some electronic waste cannot be resold or refurbished at a profit, but may still be recycled in order to avoid disposal cost or avoid an environmental risk of disposing the items (e.g., televisions, computer monitors, etc.).

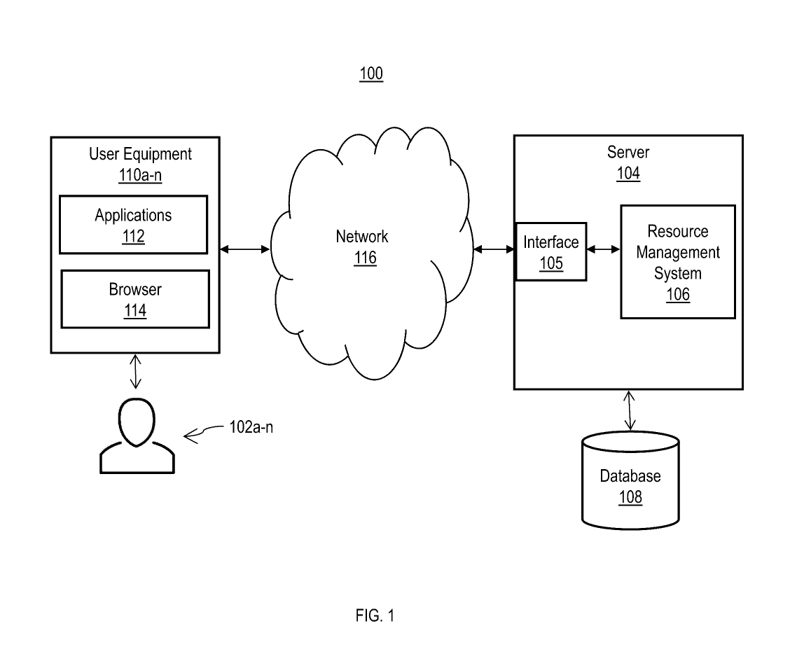

FIG. 1 depicts a system 100 according to an embodiment of the present invention. FIG. 1 is for illustration only, and should not be construed as limiting embodiments of the present invention to any particular arrangement of components. Various other system components such as a gateway, a firewall, etc., are known by persons of skill in the art of computer networking, but are not depicted in FIG. 1 in order to avoid obscuring the main components of system 100. System 100 facilitates management of resources that may be collected from households or industries associated with a plurality of customers. In an embodiment, resources may be waste resources that are no longer useful to customers. Resources may include electronic waste, textile waste, metal scrap, automotive scrap, and the like. Customers may desire to dispose waste resources but do not have appropriate collection and disposal systems. System 100 helps overcome deficiencies of traditional systems.

Customers 102a-n, generically referred to as customers 102, may submit to a server 104 a request to collect waste resources from, for example, their households, community, locality, industries, and the like, according to an embodiment of the present invention. A customer-facing communication interface 105 provides a physical-layer networking interface to receive the request from customer 102, and in turn forwards the request from customer 102 to resource management system 106. Resource management system 106 of server 104 then may receive and process the customers' requests. Resource management system 106 may also retrieve, from database 108, data associated with a customer. Database 108 may store, customers' information, such as a name, a contact number, email identification (ID), an address, benefits such as loyalty points or rewards, and the like. In another embodiment, more than one database 108 may be used in system 100 for various purposes.

Customers 102 may submit the collection request by use of user equipment 110a-n, generically referred to as user equipment 110, according to an embodiment of the present invention. User equipment 110 may include a laptop, a computer, a Personal Digital Assistance (PDA), a tablet, a smart phone, a palmtop, a notebook, a mobile phone, or any other computing device. User equipment 110 may support any type of user interface to submit the collection request. In addition, user equipment 110 may facilitate various user input devices, e.g., a touch screen, a keyboard and keypad data entry, a voice-based input mechanisms, and the like. User equipment 110 may also include other applications 112 (i.e., computer-implemented processes) such as, but are not limited to, social networking applications, communication applications, business intelligent applications, educational applications, and the like, according to an embodiment. In another embodiment user equipment 110 may include a browser 114. In an exemplary scenario, customers 102 may initiate collection requests by logging into a user account on a website of resource management system 106. In another exemplary scenario, customer 102 may submit a collection request through application 112, for example, a social networking website.

Customers' requests may be transmitted from user equipment 110 to server 104 through a network 116. Network 116 may be a telephony network, a wireless network, a data network, a service provider data network, and the like, in accordance with an embodiment of the present invention. For example, the telephony network may include a circuit-switched network, such as the Public Switched Telephone Network (PSTN), an Integrated Services Digital Network (ISDN), a Private Branch Exchange (PBX), or other like networks. The service provider network may embody circuit-switched and/or packet-switched networks that may include facilities to provide for transport of circuit-switched and/or packet-based communications. Network 116 may include components and facilities to provide signaling and/or bearer communications between the various components or facilities of system 100. In this manner, network 116 may embody or include portions of a Signaling System 7 (SS7) network, or other suitable infrastructure to support control and signaling functions. In addition, system 100 may operate as separate parts that rendezvous and synchronize periodically to form a larger system with similar characteristics. Further, the data network may be any Local Area Network (LAN), Metropolitan Area Network (MAN), Wide Area Network (WAN), the Internet, or any other suitable packet-switched network, such as a commercially owned, proprietary packet-switched network, such as a proprietary cable or fiber-optic network. Further, the wireless network may employ various technologies including, for example, Code Division Multiple Access (CDMA), Enhanced Data Rates For Global Evolution (EDGE), General Packet Radio Service (GPRS), Mobile Ad Hoc Network (MANET), Global System For Mobile Communications (GSM), 4G Long-Term Evolution (LTE), Internet Protocol Multimedia Subsystem (IMS), Universal Mobile Telecommunications System (UMTS), etc., as well as any other suitable wireless medium, for example, microwave access (WiMAX), Wireless Fidelity (WiFi), satellites, and the like.

Resource management system 106 may receive requests from customers 102 to collect the waste resources from, for example, households. In an embodiment of the present invention, resource management system 106 may facilitate customer 102 to create a user account by use of an email ID to make the request. Resource management system 106 may facilitate customers 102 to create a user account by use of a social media account, according to another embodiment. Resource management system 106 may facilitate customers 102 to create a user account by use of their contact details, for example, a mobile phone number, according to yet another embodiment. Customers 102 may use a username-password pair to login to their accounts. Customers 102 may use a pattern created on the touch interface of user equipment 110 to login to their accounts, wherein the pattern is pre-stored by customer 102 within user equipment 110, according to another embodiment. The pattern may include, for example, a gesture (e.g., a swipe), a simple figure (e.g., a hand-drawn geometric figure), a simple alphanumeric sequence (e.g., PIN number, initials, passcode, etc.).

Embodiments of resource management system 106 may facilitate customer 102 to provide information associated with the waste resources and to select a category for the waste resource. Categories of waste resources may include apparel, shoes, bed and bath, computers, printers, others, and the like. The categories may further include “other”, “miscellaneous”, or the like, for hard-to-categorize waste resources. Further, customer 102 may upload a photograph of the waste resource. In an embodiment, customer 102 may dynamically click a photograph and then upload the photograph on the website. In another embodiment, customer 102 may upload the photograph that is stored in a photo library of user equipment 110. Embodiments may use a photograph in order to help determine and schedule what assets are needed to collect the waste resource to recycle (e.g., extra workers or equipment if any, what type of collection vehicle should be dispatched such as van, small truck, flatbed trailer, etc.). The photograph may also be useful to screen the waste resources for items that may not be handled or may require special handling (e.g., toxic chemicals, radiological materials, biohazard materials, compressed gas cylinders, etc.), or may require governmental permits for lawful disposal or recycling (e.g., asbestos products), or to screen for condition (e.g., verify there are no obvious defects), or to assist collection personnel in identifying the waste resource to collect upon arrival.

Furthermore, customer 102 may select an estimated condition of the waste resource, according to an embodiment of the present invention. For example, customer 102 may qualitatively estimate a condition of the waste resource as being one of “good”, “medium”, “bad”, and so forth. A good condition may indicate an operable piece of electronic equipment, or an apparel wearable as second-hand or vintage clothing, and so forth. A medium condition may indicate electronic equipment that needs minor repair, or wearable apparel with minor problems such as a missing button, minor fraying, and so forth. A bad condition may indicate that the waste resource is not usable again, for example, torn or threadbare apparel. In another exemplary scenario, the good condition may indicate that the waste resource may be processed or recycled, a medium condition may indicate that some of the parts of the waste resource may be processed or recycled, and the bad condition may indicate that the waste resource cannot be processed or recycled. The condition of the waste resource may be used, e.g., to route the collected waste resource for further processing. For example, items in “good” condition may be immediately routed to a distribution center for refurbishment and resale. Items in a “bad” condition may be immediately routed to a scrap dealer for disposal. Items in a “medium” condition may be routed to a processing facility for further evaluation.

Moreover, resource management system 106 may provide options to customers 102 to provide additional information associated with the waste resource. In an embodiment of the present invention, the additional information may include a review of the resource, date of purchase, year of manufacture, a rating of the resource, and the like. Customer 102 then may submit the request to collect the waste resource from their household. A customer-facing communication interface 105 provides a physical-layer networking interface to receive the request from customer 102, and in turn forwards the request from customer 102 to resource management system 106. In an embodiment, customer 102 may submit a collection request for more than one waste resource. For example, customer ‘A’ may select apparel and provide information about an apparel in order to dispose the apparel, whereas, customer ‘B’ may provide information for both an apparel and a computer, for disposal of both of them.

Next, customer 102 may submit, and resource management system 106 may receive, the collection request for the waste resources from customer 102. For purpose of routing a collection vehicle, each pickup address from customer 102 is a separate destination. A routing module of resource management system 106 may determine a relatively efficient route for the collection of the waste resources from the plurality of customers 102 who have submitted a collection request within a given period of time. Given a list of destinations and the cost to travel between each pair of destinations (cost as measured by, e.g., distance, time to travel, tolls, multivariate function thereof, etc.), the routing module determines a low-cost route (i.e., ideally the least costly route) that visits each destination once and upon conclusion goes to a predetermined location (e.g., a depot to unload the collection vehicle, or a designated waiting location, etc.). The routing module may be implemented as a set of program instructions executing on the processor. Efficiency may be judged by, e.g., reducing an estimated travel time to make all collections, or reducing the number of miles to make all collections, or reducing tolls paid, and so forth. Some embodiments may apply multiple criteria simultaneously, e.g., find a fast route while keeping tolls below a predetermined threshold (e.g., zero tolls or one toll, or total tolls no more than X dollars).

By including multiple types of items to pick up on the collection route (e.g., both electronic items and apparel), the routing module can construct a relatively efficient route that reduces collection cost.

As a baseline for judging an efficient route, and using travel distance as a metric to judge efficiency, a first approximation of an efficient route may be to go to whichever of N collection locations is physically closest to the present location of the collection vehicle. After that collection, the collection vehicle may go to the closest of the remaining N-1 collection locations, and the process repeated until all collection locations are serviced. Such a route is referred to herein as a “closest pickup route”. An analysis to identify a more efficient result may then include other factors, such as a different order of collection, travel time between collection locations, whether the collection vehicle may become full after some collections (necessitating a trip back to a distribution center to unload), etc. In some circumstances when one route may reduce a first metric (e.g., distance traveled) but another route may reduce a second metric (e.g., time to travel) at a cost of a higher first metric, a weighting may be applied (e.g., dollars per hour and dollars per mile) in order to determine an efficient route taking into account multiple metrics. In some embodiments, a weighting may take into account a statistical uncertainty of the metric, e.g., travel times may vary depending upon traffic and thus may carry less weighting in close situations. In contrast, distances are fixed for a given route and thus may carry greater weighting. Some routes may be excluded if a roadway cannot accommodate commercial traffic, or vehicles over a certain height or weight.

Embodiments may wait a predetermined amount of time between collection runs in order for a sufficient number of requests to arrive within a predefined service area. A sufficient number would be one that is likely to utilize at least a threshold cargo capacity of a collection vehicle (e.g., a truck) for a route within the service area, without risking user antagonism about a delay in scheduling a collection. Cargo capacity criteria may include weight, volume, interior dimensions, exterior dimensions (e.g., trailer size, roof rack size, etc.), or any combination of criteria. For example, vehicles may be dispatched once per day, once per week, twice per week, etc. within a service area, depending upon volume in the service area. There may exist several overlapping or non-overlapping service areas within a geographic region, depending upon collection request volume. Alternatively, service area boundaries may vary depending upon a volume of received collection requests. In other embodiments and circumstances, a collection vehicle may be dispatched relatively quickly after receiving a submitted request, e.g., if picking up an item of high expected value, or if the collection location is relatively close to a present location of the collection vehicle, or if the size or other characteristic of the waste resource makes it impractical to combine a collection of the waste resource with a collection of another waste resource, or upon customer request for expedited service.

Some embodiments of resource management system 106 may calculate an estimated collection date and/or collection time to collect the waste resources from respective customers. In another embodiment, resource management system 106 may calculate more than one collection date and/or collection time to collect the waste resources. In an exemplary scenario, resource management system 106 may calculate that on January 3rd, collection times on separate routes (or separate runs on a same route) may be 8:00 AM, 1:00 PM, and 5:30 PM. In another exemplary scenario, the resource management system 106 may calculate that on January 3rd and January 4th, the waste resources may be collected at 9:00 AM on a single route.

Resource management system 106 may use one or more of various communication channels to communicate with customer 102. Communication channels may include, e.g., an email, a Short Messaging Service (SMS), a text message, a web message, a message on a social networking website, a voice call, a video call, a Voice over Internet Protocol (VoIP) call, and the like. A scheduling module of resource management system 106 may use one or more of these communication channels to prompt customer 102 to provide a selection of an appropriate or preferred date and/or time at which the waste resources may be collected. Thereafter, the scheduling module of resource management system 106 may receive the customer's selection of the appropriate date and/or time to collect the waste resources. For example, customer 102 may select a preferred collection date/time appointment of January 3rd at time 8:00 AM.

Further, resource management system 106 may provide notifications to customer 102, using one or more of the communication channels. Notifications may include a reminder of a waste resource collection, any delay in collection, a status of accrued loyalty points, etc. Embodiments may provide the notifications periodically (e.g., for a periodic collection) or as needed (e.g., if a service delay is expected).

Upon collection, embodiments of resource management system 106 may attempt to verify automatically at least some information provided by customer 102. For example, resource management system 106 may include a condition verification module to verify if possible the customer-provided qualitative grade estimate. For example, a high-resolution photograph may be taken and analyzed by computer-implemented processes to identify any apparent defects, e.g., a cracked screen on an electronic device, torn clothing, missing parts, chipped, cracked or scratched items, etc. Such processes may be more effective in identifying physical defects rather than operating defects, e.g., a TV that will not turn on or has degraded picture quality. In some embodiments, a computer-verified quality score may be compared to a customer-provided quality score, and the result of the comparison may be stored with customer information. Divergent results may be an indication of a reduced weighting, trust, or reliance upon future condition grade estimates provided by the customer, or that future items picked up from the customer need to be examined more carefully.

Upon collection, and verification if performed, resource management system 106 may include an assignment module to assign each collected waste resource to one of a set of categories. The categories may indicate a disposition of the waste resource, e.g., (1) to resell as used goods (e.g., as vintage clothing), or (2) to examine further for possible refurbishment, or (3) to sell for scrap value, or (4) to discard. Discarding an item may include sending the waste resource to a traditional landfill.

The assignment module may be implemented as a set of program instructions executing on the processor. The assignment module may use product photographs submitted by customer 102 to help identify the highest-value disposition of collected items, and to help avoid inventory costs. For example, image recognition processes may detect items in the product photographs, may detect conditions that may affect value (e.g., apparent broken items), and assign a category of disposition (e.g., one of categories (1)-(4) discussed above).

Loyalty points may be allocated to customers 102 based on factors such as an amount of waste resources recycled by customer 102, or based on the frequency of disposing waste resources, etc. For example, if customer ‘A’ disposes waste resources every three months, and customer ‘B’ disposes waste resources once per year, then customer ‘A’ will earn more frequency-based loyalty points as compared to customer ‘B’. On the other hand, if customer ‘B’ disposes more amount of waste resources once per year than customer ‘A’ who disposes waste resources every three months, then more quantity-based loyalty points may be allocated to customer ‘B’ than customer ‘A’.

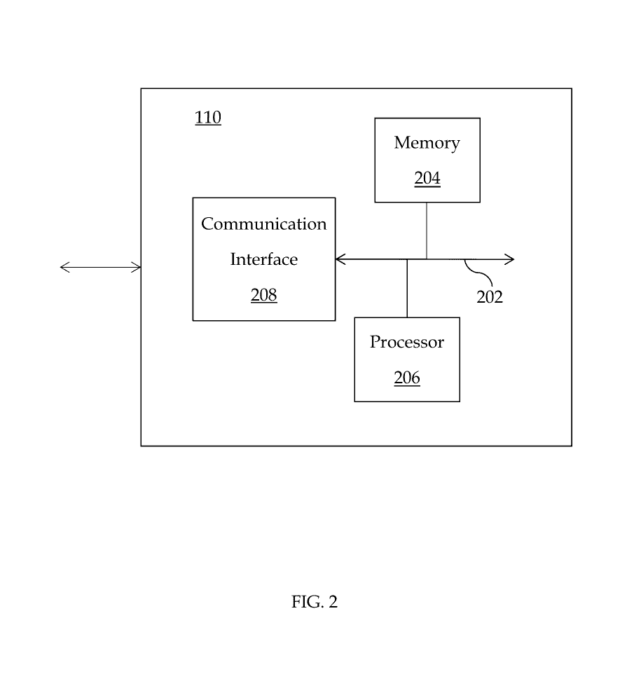

FIG. 2 illustrates at a relatively high-level hardware abstraction of a block diagram of server 104, in accordance with an embodiment of the present invention. Typically, server 104 is a stored-program-controlled system that may include an internal communication interface 202 to external communication links, a communications switching fabric, service circuits, a memory 204 that may store control programs and data, and a processor 206 that may execute the stored control programs to control communication interfaces 208 and the switching fabric. Communication interface circuit 208 may include a receiver and transmitter (not shown) to communicate with other elements such as a switch, a security gateway, a LAN, and so forth. By use of sets of programming code and data stored in memory 204, processor 206 may be programmed to carry out various functions of server 104 in accordance with embodiments as described herein above and below. Other types of known servers are well known in the art and therefore not described in detail herein.

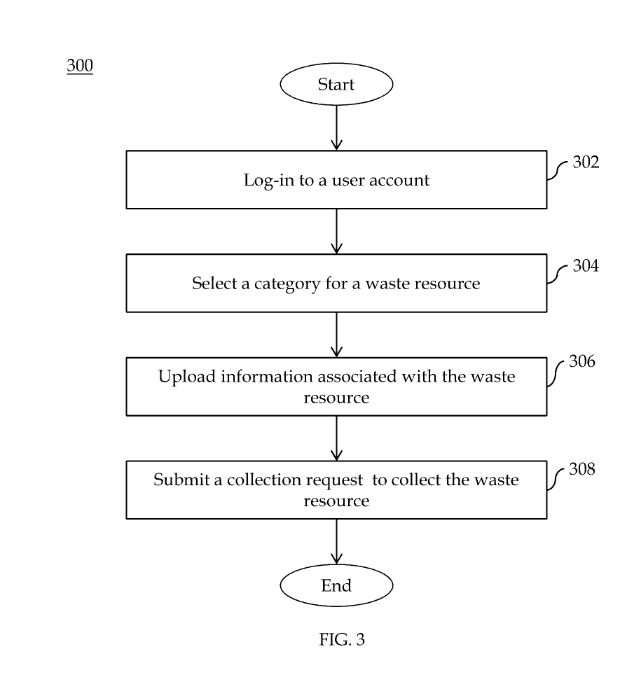

FIG. 3 illustrates a method 300 to request collection of waste resources, according to an embodiment of the present invention.

At step 302, customer 102 logs in to a user account that is used to submit a request to collect waste resources. Customer 102 may use a username-password pair to login to the user account, in an embodiment Customers 102 may use a pattern created on the touch interface of user equipment 110 to login to their accounts, wherein the pattern is pre-stored by customer 102 within user equipment 110, according to another embodiment. The pattern may include, for example, a gesture (e.g., a swipe), a simple figure (e.g., a hand-drawn geometric figure), a simple alphanumeric sequence (e.g., PIN number, initials, passcode, etc.). In another embodiment, customer 302 may use biometric data of customer 302 (e.g., retina, iris, fingerprint, face or voice recognition, etc.) to log into the user account.

At step 304, customer 102 selects a category for the waste resource, according to an embodiment of the present invention. Categories may include, e.g., apparel, shoes, bed and bath, computers, printers, miscellaneous, and the like. Categories may be hierarchical and selected in several parts (e.g., men's or women's apparel, followed by type of apparel (e.g., shirts, pants, formal wear, outerwear, etc.), color description, etc.).

Next, at step 306, customer 102 may upload information associated with the waste resource, e.g., a picture of the waste resource. In an embodiment, customer 102 may upload a picture simply by clicking on the picture or a listing of the picture (e.g., in a file list box, Windows Explorer, etc.). In another embodiment, customer 102 may select a picture stored in a photo library of user equipment 110 and then upload the picture. In another embodiment, customer 102 may select a condition of the waste resource, as previously described.

Thereafter, at step 308, customer 102 submits a collection request to collect the waste resources, e.g., from the customer's home. In another embodiment, waste resources may be collected from the customer's workplace, such as an office. Embodiments may provide to customer 102 a confirmation of receiving the request and/or a scheduled collection date/time appointment.

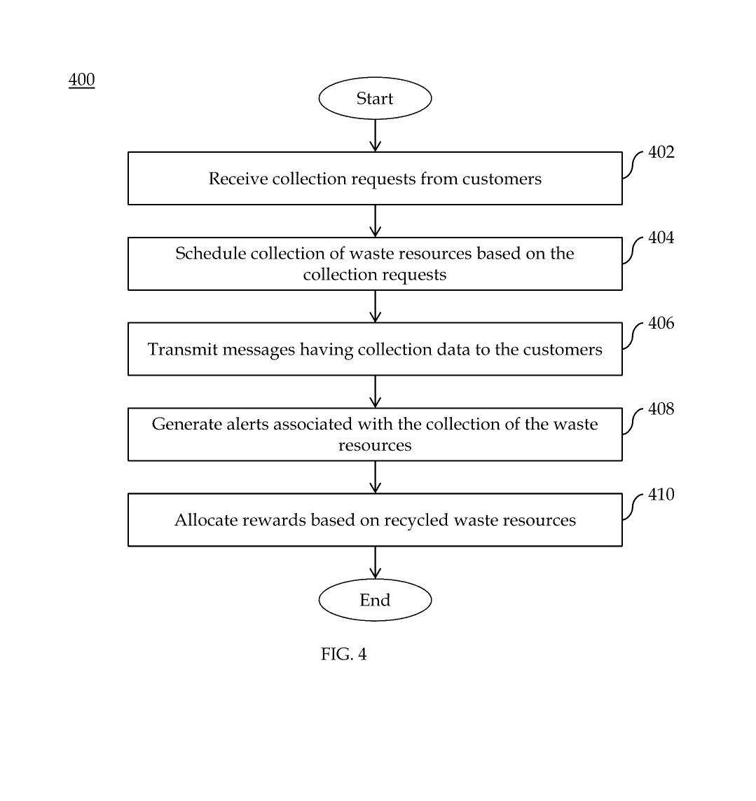

FIG. 4 illustrates a method to manage collection of waste resources, according to an embodiment of the present invention. At step 402, resource management system 106 receives collection requests from various customers. In an exemplary scenario, requests to collect waste resources may be received from four customers.

Next, at step 404, scheduling module of resource management system 106 schedules collection of the waste resources based on the received requests, according to an embodiment of the present invention. Scheduling module of resource management system 106 may schedule collections based on factors such as customer addresses, or customer-preferred collection dates and/or collection times. For example, waste resources may be collected from customer ‘A’ at 6 AM, from customer ‘B’ at 6:15 AM, from customer ‘C’ at 6:30 AM, and from customer ‘D’ at 7 AM. Customer-preferred collection dates and/or collection times may be known to embodiments by asking the customer, or by allowing the customer to self-configure or self-schedule preferred collection dates and/or collection times.

In some embodiments, a customer-preferred collection time may refer to a specific time or may refer to a time window. A customer-preferred collection time may cause recalculation of an efficient route to collect all waste resourced planned for pickup, so that the collection vehicle should arrive within a predetermined time window around the customer-preferred collection time (e.g., +/−one hour), or within a time window provided by customer 102 (e.g., “come in the afternoon”), or after a time specified by customer 102 (e.g., “I'll leave it out after 9:00 AM”), or before a time specified by customer 102 (e.g., “it has to be gone by 5:00 pm”). In some embodiments, limits to a time window may be set by rules within scheduling module of resource management system 106 unless overridden by request from customer 102 (e.g., do not pick up before 7:00 AM or after 7:00 PM, do not pick up after local sundown, etc.). In some embodiments, customer 102 may indicate whether the customer-preferred collection is optional (e.g., customer may leave out a bag of clothing for pickup), or is required (e.g., if customer presence is needed to gain access to the waste resource in a house, etc.). If customer presence is required, the customer-preferred collection time will be assigned a greater weight when calculating an efficient route, as compared to when the customer-preferred collection time is optional.

At step 406, resource management system 106 may transmit messages or notifications to customers, e.g., to remind or confirm collection dates/times, or to inform customer 102 of a service delay or cancellation, etc. The message may be transmitted to the customers through one or more of various communication channels, as previously described. In an embodiment, notifications may be transmitted periodically or more than once to at least some customers.

Furthermore, resource management system 106 allocates rewards to customers, according to an embodiment of the present invention. In one embodiment, resource management system 106 may allocate rewards to customers based on an amount or quantity of waste resources recycled. In another embodiment, resource management system 106 may allocate rewards to the customers based on a frequency of disposing the waste resources. In yet another embodiment, resource management system 106 may allocate a fixed amount of reward to each customer. In another embodiment, the resource management system 106 may allocate rewards to customers based on a total amount or value of waste resources collected from all customers, and distributed to individual customers either as a fixed share of the total, or in proportion to the contribution from respective individual customers.

The reward may be a financial reward (e.g., monetary reward) or substantially any other type of rewards feasible in the context of the present embodiments. Examples of financial rewards may include cash, a credit, a gift certificate, a gift card, coupons, etc. In another embodiment, rewards may include points or tokens redeemable for a financial reward. The reward may be allocated electronically to customers (e.g., a transaction between two bank accounts, an entry into an electronic database, PayPa1™, etc.), or issued physically to customers through, e.g., a check, a money order, a certificate, and the like.

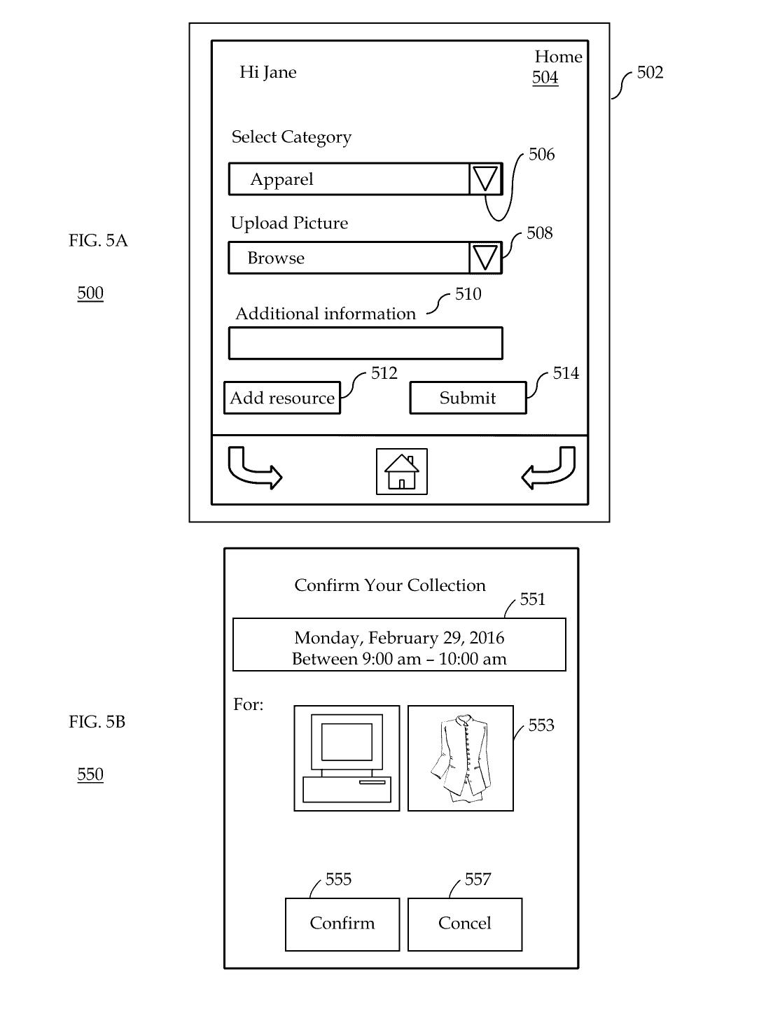

FIG. 5A illustrates an interface 500 of a mobile device to submit a request to collect waste resources, according to an embodiment of the present invention. A customer ‘Jane’ desires to dispose-off waste resources, e.g., apparel. After the customer uses mobile device 502 to log into a user account, and mobile device 502 displays home page 504, the customer may then select a category 506 by use of a drop down list. The list may include, e.g., apparel, shoes, bed and bath, computers, printers, and the like. Further, the customer may upload a picture of apparel by browsing picture 508 from a photo library of mobile device 502. Furthermore, the customer may add additional information 510 associated with the apparel. Additional information may include, e.g., date of purchase, quantity of the apparel, brand name, etc. Next, the customer may also add another waste resource by clicking on a add resource button 512 or the customer may submit the information by clicking on submit button 514.

Upon submission of a request through interface 500, a confirmation screen such as interface 550 of FIG. 5B may be presented on the mobile device to the user. Interface 500 may include elements such as field 551 listing the date/time of appointment, field(s) 553 showing a visual confirmation of the items to collect, and controls 555, 557 to either confirm or cancel the appointment.

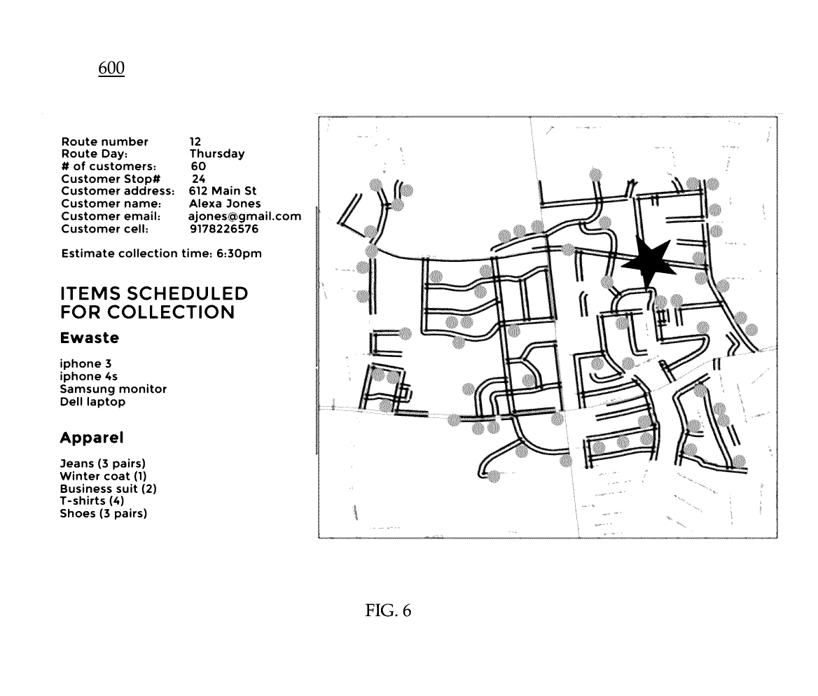

FIG. 6 illustrates a route report 600 in accordance with an embodiment of the present disclosure. Route Report 600 may include, e.g., a map showing pickup locations, a summary of what to pick up at each destination and/or for the route as a whole, and so forth.

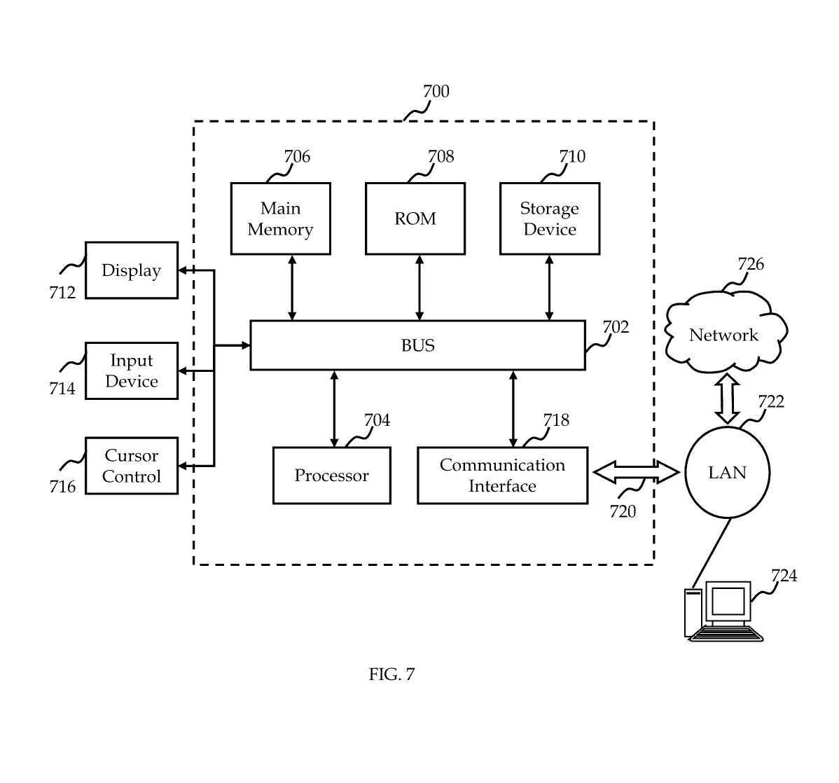

FIG. 7 illustrates a computing hardware (e.g., a mobile system) 700 on which exemplary embodiments may be implemented. Mobile system 700 includes a bus 702 or other communication mechanism to communicate information and a processor 704 coupled to bus 702 to process information. Mobile system 700 also includes a main memory 706, such as a Random Access Memory (RAM) or other dynamic storage device, coupled to bus 702 to store information and instructions to be executed by processor 704. Main memory 706 also may be used to store temporary variables or other intermediate information during execution of instructions by processor 704. Mobile system 700 further may include a Read Only Memory (ROM) 708 or other static storage device coupled to bus 702 to store static information and instructions for processor 704. A storage device 710, such as a magnetic disk or an optical disk, is coupled to bus 702 to store information and instructions persistently.

Mobile system 700 may be coupled via bus 702 to a display 712, such as a Cathode Ray Tube (CRT), a liquid crystal display, an active matrix display, or a plasma display, to display information to a mobile user. An input device 714, such as a keyboard including alphanumeric and other keys, is coupled to bus 702 to communicate information and command selections to processor 704. Another type of a user input device may be a cursor control 716, such as a mouse, a trackball, or cursor direction keys, to communicate direction information and command selections to processor 704 and to control cursor movement on display 712.

According to an exemplary embodiment, processes described herein are performed by mobile system 700, in response to processor 704 executing an arrangement of instructions contained in main memory 706. Such instructions may be read into main memory 706 from another computer-readable medium, such as storage device 710. Execution of instructions contained in main memory 706 causes processor 704 to perform process steps described herein. One or more processors in a multi-processing arrangement may also be employed to execute instructions contained in main memory 706. In alternative embodiments, hard-wired circuitry may be used in place of or in combination with software instructions to implement exemplary embodiments. Thus, exemplary embodiments are not limited to any specific combination of hardware circuitry and software.

Mobile system 700 may also include a communication interface 718 coupled to bus 702. Communication interface 718 provides a two-way data communication coupling to a network link 720 connected to a Local Area Network (LAN) 722. For example, communication interface 718 may be a Digital Subscriber Line (DSL) card or modem, an Integrated Services Digital Network (ISDN) card, a cable modem, a telephone modem, or any other communication interface to provide a data communication connection to a corresponding type of communication line. As another example, communication interface 718 may be a Local Area Network (LAN) card (e.g., for Ethernet™ or an Asynchronous Transfer Mode (ATM) network) to provide a data communication connection to a compatible LAN. Wireless links may also be implemented, in one embodiment. In such implementation, communication interface 718 may send and receives electrical, electromagnetic, or optical signals that carry digital data streams representing various types of information. Further, communication interface 718 may include peripheral interface devices, such as a Universal Serial Bus (USB) interface, a Personal Computer Memory Card International Association (PCMCIA) interface, etc. Although FIG. 7 depicts a single communication interface 718, multiple communication interfaces also may be employed.

Network link 720 typically provides data communication through networks to other data devices. For example, network link 720 may provide a connection through LAN 722 to a host computer 524, which has connectivity to a network 726 (e.g., a Wide Area Network (WAN) or a global packet data communication network now commonly referred to as the “Internet”) or to data equipment operated by a service provider. LAN 722 and network 726 both use electrical, electromagnetic, or optical signals to convey information and instructions. Exemplary forms of carrier waves bearing information and instructions include signals through various networks and signals on network link 720 and through communication interface 718, which communicate digital data with mobile system 700.

Mobile system 700 may send messages and receive data, including program code, through network 726, network link 720, and communication interface 718. In the Internet example, a server (not shown) might transmit requested code, belonging to an application program, through network 726, LAN 722 and communication interface 718. Processor 704 may execute transmitted code while being received and/or store the code in storage device 710, or other non-volatile storage for later execution. In this manner, mobile system 700 may obtain application code in the form of a carrier wave.

Various embodiments described herein confer benefits across a value chain of a product at the end of its usefulness to a consumer. For example, customer 102 may have products that no longer are useful to the owner, or do not have enough benefit to the owner to keep them. Such products may include old clothes and unwanted or obsolete electronics. Embodiments provide solutions to customer 102 by offering a convenient way to dispose of old clothes, electronics, and the like. For haulers and entities that contract with haulers (e.g., cites and municipalities), conventional solutions of sending discarded but recyclable articles to landfills is expensive (e.g., due to tipping fees) and depletes landfill space. In contrast, embodiments provide a way for haulers and cities to reduce the waste stream, thereby reducing tipping fees, conserving landfill space, and generating a new source of revenue. For textile and electronic recyclers, conventional solutions lead to a greater demand for recyclable goods than the existing infrastructure can accommodate. In contrast, embodiments provide an organized infrastructure to provide adequate recyclable articles, and may stimulate new uses or markets for recyclable articles due to a greater availability of recyclable articles. For brand owners (e.g., manufacturers), conventional solutions fail to provide a way to gather feedback regarding how their products perform or withstand usage in real-life situations. In contrast, embodiments provide an infrastructure that can be organized to examine collected articles and give feedback to brand owners about any frequently-observed traits (e.g., that a certain type of smart phone screen is often broken, etc.).

Embodiments in accordance with the present disclosure provide numerous benefits compared to the background art for the collection of recyclable items. First, mailing recyclable items to a collection center suffers from a low participation rate due to inconvenience, and in practice is limited to high-value items. In contrast, embodiments are able to accept substantially all kinds of recyclable waste, with greater convenience to consumers.

Second, taking recyclable items back to a retail location (e.g., “bricks and mortar store”) suffers from inconvenience, and low participation by retailers, and often times fees charged by retailers. In contrast, embodiments focus on consumer convenience (e.g., collection vehicle comes to the consumer), and once collected there is opportunity to find a high-value resale market (e.g., because the quantity of material collected stimulates knowledge of and markets for the recycled materials), while keeping storage and inventory cost low through fast turnover.

Third, one-at-a-time on-demand pickups of recyclable items is inefficient and costly (including usage or other resources such as vehicle fuel). In contrast, embodiments handle a large number of collection requests within a limited geographic area and time window, thus spreading fixed costs (e.g., overhead, cost of collection vehicle, etc.) over a larger number of items, making lower-value items more economical to recycle.

Fourth, municipal drop-off of recyclable items (e.g., a collection bin in a parking lot) suffers from a physical limit on the quantity of material that can be collected before the bins need to be emptied. Fragile electronic items may break when dropped into a bin, and items may be damaged (e.g., by water leakage, vermin, mildew in the containers, etc.). Drop-off is also inconvenient to consumers 102. In contrast, embodiments focus on consumer convenience by having a collection vehicle coming to the consumer.

The term “computer-readable medium” as used herein refers to any medium that participates in providing instructions to processor 704 for execution. Such a medium may take many forms, including but not limited to non-volatile media, volatile media, and transmission media. Non-volatile media may include, for example, optical or magnetic disks, such as storage device 710. Volatile media may include a dynamic memory, such as main memory 706. Transmission media may include coaxial cables, copper wire and fiber optics, including wires that include bus 702. Transmission media may also take the form of acoustic, optical, or electromagnetic waves, such as those generated during Radio Frequency (RF) and infrared (IR) data communications. Common forms of computer-readable media may include, for example, a floppy disk, a flexible disk, hard disk, magnetic tape, any other magnetic medium, a CD-ROM, a Compact Disc-Rewritable (CDRW), a Digital Video Disk (DVD), any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read. In certain cases, computer readable media may include an unknown physical component wherein information is uniquely defined by a special digital unique identifier and is available through multiple physical channels either simultaneously or exclusively.

Various forms of computer-readable media may be involved in providing instructions to a processor for execution. For example, instructions to carry out at least part of the exemplary embodiments initially may be stored on a magnetic disk of a remote mobile device. In such a scenario, the remote mobile device loads instructions into main memory and sends instructions over a telephone line using a modem. A modem of a local computer system receives data on a telephone line and uses an infrared transmitter to convert data to an infrared signal and transmit the infrared signal to a portable computing device, such as a Personal Digital Assistant (PDA) or a laptop. An infrared detector on the portable computing device receives information and instructions transmitted by the infrared signal and places data on a bus. The bus conveys data to a main memory, from which a processor retrieves and executes instructions. Instructions received by main memory can optionally be stored on storage device either before or after execution by processor.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

A module that performs a function also may be referred to as being configured to perform the function, e.g., a data module that receives data also may be described as being configured to receive data. Configuration to perform a function may include, for example: providing and executing sets of computer code in a processor that performs the function; providing provisionable configuration parameters that control, limit, enable or disable capabilities of the module (e.g., setting a flag, setting permissions, setting threshold levels used at decision points, etc.); providing a physical connection, such as a jumper to select an option, or to enable/disable an option; attaching a physical communication link; enabling a wireless communication link; providing electrical circuitry that is designed to perform the function without use of a processor, such as by use of discrete components and/or non-CPU integrated circuits; energizing a circuit that performs the function (e.g., providing power to a transceiver circuit in order to receive data); and so forth.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed. Modifications and variations are possible in light of the above teachings or may be acquired from practice of the disclosure. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

Moreover, the claims should not be read as limited to the described order or elements unless stated to that effect. In addition, use of the term “means” in any claim is intended to invoke 35 U.S.C. §112(f), and any claim without the word “means” is not so intended.

What is claimed is:

1. A resource management system, comprising:
a processor coupled to a memory, the memory configured to store sets of program instructions;
a customer-facing communication interface coupled to the processor, the communication interface configured to receive a request from a customer to collect a waste resource and to receive an information about the waste resource;
a routing module, provided by a set of program instructions executing on the processor, the routing module configured to determine a route to collect the waste resource from a collection location;
a scheduling module, provided by a set of program instructions executing on the processor, the scheduling module configured to schedule an appointment to collect the waste resource using the determined route; and
an assignment module, provided by a set of program instructions executing on the processor, the assignment module configured to categorize the collected waste resource.

2. The system of claim 1, wherein routing module is configured to determine a route to collect waste resources from a plurality of collection locations.

3. The system of claim 1, wherein the information about the waste resource comprises a customer-estimated condition of the waste resource.

4. The system of claim 1, wherein the information about the waste resource comprises a customer-preferred collection time.

5. The system of claim 1, wherein the routing module is configured to search for a more efficient route than a closest pickup route.

6. The system of claim 5, wherein a metric to analyze the more efficient route comprises a metric selected from a group consisting of distance, travel time, tolls paid and capacity of a collection vehicle to contain waste resources.

7. The system of claim 1, wherein the routing module is configured to determine a route for a collection vehicle to arrive at a collection location within a predetermined window around a collection time.

8. The system of claim 1, wherein the routing module is configured to determine a route for a collection vehicle to arrive at a collection location after a predetermined collection time.

9. The system of claim 1, wherein the routing module is further configured to wait at least a predetermined amount of time after receiving the request from the customer before determining a route to pick up the waste resource.

10. The system of claim 1, further comprising an assessment module, provided by a set of program instructions executing on the processor, wherein the assessment module is configured to assess a condition of the waste resource, separate from the customer-estimated condition of the waste resource.

11. A method to collect waste resources, comprising:
receiving, via a customer-facing communication interface coupled to a processor, a request from a customer to collect a waste resource and an information about the waste resource;
waiting a predetermined amount of time to receive additional requests from customers to collect waste resources, to produce a plurality of collection requests;
routing, by a set of routing instructions executing on the processor, a route for a collection vehicle to service each collection request of the plurality of collection requests;
scheduling, by a set of scheduling instructions executing on the processor, a plurality of appointments to collect the waste resources from the plurality of collection requests, by use of the route;
collecting the waste resources by use of the route and the plurality of appointments.

12. The method of claim 11, further comprising the steps of:
capturing a photograph of an item to collect; and
transmitting the photograph over the customer-facing communication interface to the processor.

13. The method of claim 11, further comprising the step of:
assigning, by a set of assigning instructions executing on the processor, a respective category to each of the collected waste resources.

14. The method of claim 13, further comprising the step of:
wherein the step of assigning is by use of the information about the waste resource provided by the customer.

15. The method of claim 11, further comprising the step of:
confirming, by a set of schedule-confirmation instructions executing on the processor, an appointment to collect the waste resources.

16. The method of claim 11, wherein the step of routing comprises determining a route having at least a predetermined level of efficiency.

17. The method of claim 11, wherein the step of scheduling comprises soliciting a preferred collection time from a customer.

18. The method of claim 11, further comprising a step of assigning the waste resource to a disposition selected from a group consisting of reselling, refurbishing, scrapping and discarding.

19. The method of claim 18, further comprising the step of:
assessing a condition of the waste resource; and
selecting the disposition based upon the assessed condition.

20. The method of claim 19, further comprising a step of verifying the condition of the waste resource after collection.
